(19) United States
(12) Patent Application Publication
(10) Pub. No.: US 2026/0089648 A1
(43) Pub. Date: Mar. 26, 2026

(54) METHOD AND APPARATUS FOR REPORTING POWER HEADROOM INFORMATION, AND DEVICE, STORAGE MEDIUM AND CHIP

(71) Applicant: Beijing Xiaomi Mobile Software Co., Ltd., Beijing (CN)

(72) Inventors: Yi XIONG, Beijing (CN); Yumin WU, Beijing (CN)

(73) Assignee: Beijing Xiaomi Mobile Software Co., Ltd., Beijing (CN)

(21) Appl. No.: 19/111,771

(22) PCT Filed: Sep. 16, 2022
(86) PCT No.: PCT/CN2022/119465

§ 371 Date: Mar. 13, 2025

(51) Int. Cl. H04W 52/36

(52) U.S. Cl. CPC H04W 52/365

(57) ABSTRACT

A method for reporting power headroom information is performed by a user equipment and includes: receiving configuration information transmitted by a network device, wherein the configuration information comprises information for configuring a candidate cell group; and determining, based on the configuration information, whether to perform power headroom report.

### CROSS REFERENCE TO RELATED APPLICATIONS

This application is a National Phase of International Application No. PCT/CN2022/119465, filed on Sep. 16, 2022, the entire contents of which are incorporated herein by reference in their entireties.

### TECHNICAL FIELD

The present disclosure relates to the field of communication technologies, and in particular to a method and apparatus for reporting power headroom information, and a device, a storage medium and a chip.

### BACKGROUND

Multi-radio dual connectivity (MR-DC) is a generalized intra evolved universal terrestrial radio access (Intra-E-UTRA) dual connectivity technology. Based on this technology, a user equipment (UE) can utilize two different radio resources through scheduling, and the scheduling is located on two different next generation-radio access network (NG-RAN) nodes. One radio resource provides new radio (NR) access, and the other radio resource provides E-UTRA or NR access. One radio resource serves as a master node (MN), and the other radio resource serves as a secondary node (SN). The MN and the SN are connected through a network interface, and at least MN is connected to the core network. In the MR-DC, the network configures the UE with selective activation of cell groups through configuration information, so that the terminal can perform subsequent configuration according to the information of selective activation after a cell group (CG) is changed, without the need for the network to reconfigure or reinitialize the configuration for selective activation of the corresponding cell group. Therefore, signaling overhead and the interruption time of CG change can be reduced.

Power headroom report (PHR) is configured to report a difference between the current maximum transmitting power of the UE and the estimated uplink transmission power to the network to assist the network in uplink scheduling. In the process of communication using MR-DC technology, the network configures the UE with selective activation of cell groups through configuration information. When the UE receives the configuration for selective activation of the cell groups, in order to reduce the delay of selective activation of the cell groups, it can apply the configuration information of radio resource control (RRC) reconfiguration to selectively activate or deactivate the cell group. In the related art, when the UE performs the configuration of selective activation of cell groups and the operation of activating cell groups, it is not clear how to trigger reporting of the PHR for cell groups, which leads to the failure of the network to perform uplink scheduling according to the PHR.

### SUMMARY

To overcome the problems in the related art, embodiments of the present disclosure provide a method and apparatus for reporting power headroom information, and a device, a storage medium and a chip.

According to a first aspect of embodiments of the present disclosure, there is provided a method for reporting power headroom information. The method is performed by a user equipment (UE), and includes: receiving configuration information transmitted by a network device, where the configuration information includes information for configuring a candidate cell group; and determining, based on the configuration information, whether to perform power headroom report.

According to a second aspect of embodiments of the present disclosure, there is provided a method for reporting power headroom information. The method is performed by a network device, and includes: transmitting configuration information to a user equipment, where the configuration information includes information for configuring a candidate cell group, and the configuration information is configured to instruct the user equipment to determine, based on the configuration information, whether to perform power headroom report.

According to a third aspect of embodiments of the present disclosure, there is provided an electronic device, which includes: a processor; and a memory storing instructions executable by the processor; where the instructions, when executed by the processor, cause the processor to perform the method for reporting power headroom information according to the first aspect.

According to a fourth aspect of embodiments of the present disclosure, there is provided a network device, which includes: a processor; and a memory storing instructions executable by the processor; where the instructions, when executed by the processor, cause the processor to perform the method for reporting power headroom information according to the second aspect.

According to a fifth aspect of embodiments of the present disclosure, there is provided a non-transitory computer-readable storage medium, storing computer program instructions thereon, where the computer program instructions, when executed by a processor, cause the processor to perform the method for reporting power headroom information according to the first aspect or the method for reporting power headroom information according to the second aspect.

According to a sixth aspect of embodiments of the present disclosure, there is provided a chip, which includes a processor and an interface. The processor is configured to read instructions to perform the method for reporting power headroom information according to the first aspect or the method for reporting power headroom information according to the second aspect.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating a method for reporting power headroom information according to an embodiment of the present disclosure.

FIG. 2 is a schematic diagram illustrating a dual connectivity network architecture according to an embodiment of the present disclosure.

FIG. 3 is a schematic diagram illustrating a dual connectivity network architecture according to another embodiment of the present disclosure.

FIG. 4 is a schematic diagram illustrating a cell distribution according to an example of the present disclosure.

FIGS. 5A and 5B are a flowchart illustrating a method for reporting power headroom information according to an embodiment of the present disclosure.

FIGS. 6A and 6B are a flowchart illustrating a method for reporting power headroom information according to an embodiment of the present disclosure.

FIG. 7 is a flowchart illustrating a method for reporting power headroom information according to an embodiment of the present disclosure.

FIG. 8 is a flowchart illustrating a method for reporting power headroom information according to an embodiment of the present disclosure.

FIGS. 9A and 9B are a flowchart illustrating a method for reporting power headroom information according to an embodiment of the present disclosure.

FIG. 10 is a flowchart illustrating a method for reporting power headroom information according to an embodiment of the present disclosure.

FIG. 11 is a flowchart illustrating a method for reporting power headroom information according to an embodiment of the present disclosure.

FIG. 12 is a flowchart illustrating a method for reporting power headroom information according to an embodiment of the present disclosure.

FIG. 13 is a flowchart illustrating a method for reporting power headroom information according to an embodiment of the present disclosure.

FIG. 14 is a flowchart illustrating a method for reporting power headroom information according to an embodiment of the present disclosure.

FIG. 15 is a flowchart illustrating a method for reporting power headroom information according to an embodiment of the present disclosure.

FIG. 16 is a flowchart illustrating a method for reporting power headroom information according to an embodiment of the present disclosure.

FIG. 17 is a flowchart illustrating a method for reporting power headroom information according to an embodiment of the present disclosure.

FIGS. 18A and 18B are a flowchart illustrating a method for reporting power headroom information according to an embodiment of the present disclosure.

FIG. 19 is a flowchart illustrating a method for reporting power headroom information according to an embodiment of the present disclosure.

FIG. 20 is a flowchart illustrating a method for reporting power headroom information according to an embodiment of the present disclosure.

FIG. 21 is a flowchart illustrating a method for reporting power headroom information according to an embodiment of the present disclosure.

FIG. 22 is a structural schematic diagram illustrating an apparatus for reporting power headroom information according to an embodiment of the present disclosure.

FIG. 23 is a structural schematic diagram illustrating an apparatus for reporting power headroom information according to another embodiment of the present disclosure.

FIG. 24 is a block diagram illustrating a user equipment according to an embodiment of the present disclosure.

FIG. 25 is a block diagram illustrating a network device according to an embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

It will be further understood that “plurality” in the present disclosure means two or more, and other quantifiers are similar. The wording “and/or” describes an association relationship of an associated object, and indicates that three relationships may exist, e.g., A and/or B, which may be expressed as: A alone, both A and B, and B alone. The character “/” generally indicates an “or” relationship between the related objects. The terms “a”, “the” and “said” in their singular forms in the present application and the appended claims are also intended to include plurality, unless clearly indicated otherwise in the context.

It will be understood that the terms, such as “first”, “second”, etc., may be used to describe various information, such information should not be limited to these terms. These terms are used only to distinguish the same type of information from each other, and do not indicate a particular order or level of importance. Indeed, the expressions “first” and “second” are used interchangeably. For example, without departing from the scope of the present disclosure, first instruction information may also be referred to as second instruction information, and similarly, the second instruction information may also be referred to as the first instruction information.

It will be further understood that the embodiments of the present disclosure, while describing operations in a particular order in the accompanying drawings, should not be construed as requiring that the operations be performed in the particular order shown or in a serial order, or that all of the operations shown be performed in order to obtain a desired result. In some embodiments, multitasking and parallel processing are also possible or may be advantageous.

It is to be noted that all the actions of obtaining signals, information or data in the present disclosure are carried out under the premise of complying with the corresponding data protection laws and policies of the country where it is located and obtaining authorization from the corresponding device owner.

FIG. 1 is a flowchart illustrating a method for reporting power headroom information according to an embodiment of the present disclosure. As shown in FIG. 1, the method is performed by a UE, and includes the following steps S101 and S102.

At step S101, configuration information transmitted by a network device is received, where the configuration information includes information for configuring a candidate cell group.

This embodiment is applied to UE, which is capable of wireless communication with the network device accessing the core network using the multi-radio dual connectivity (MR-DC) technology. The MR-DC include multiple network devices, which can be 4th generation (4G) network devices and/or 5th generation (5G) network devices, and evolved 4G network devices and/or evolved 5G network devices. The UE establishes wireless connection with two network devices in the MR-DC network architecture for data communication, and the network device may be a combination of a 4G network device and a 5G network device, or a combination of a 5G network device and a 5G network device. In the MR-DC, the core network can be an evolved packet core (EPC) or a 5G core (5GC). Therefore, according to the different core networks, the MR-DC can be divided into the following two network architectures.

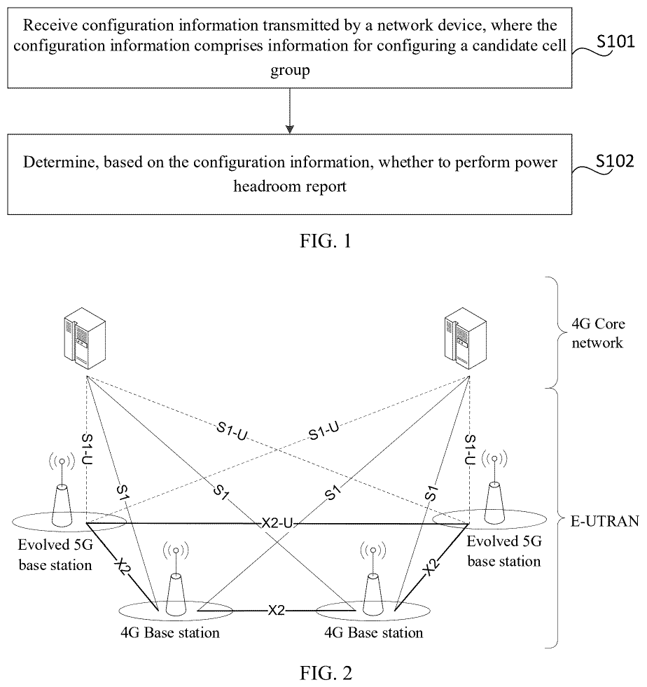

FIG. 2 is a schematic diagram illustrating a dual connectivity network architecture according to an embodiment of the present disclosure. As shown in FIG. 2, in the dual connectivity network architecture, the core network to which the MR-DC technology is applied to connect is an EPC.

By connecting an evolved universal mobile telecommunications system (UMTS) terrestrial radio access network (E-UTRAN) with new radio dual connectivity (NR-DC, dual connectivity of NR or gNB+NR or gNB in a 5G network), a dual connectivity network EN-DC (E-UTRA-NR dual connectivity) (dual connectivity of 4G network and 5G network) supporting the MR-DC technology is formed. The UE is connected to an eNB (evolved 4G base station) serving as a master node (MN) and an en-gNB serving as a secondary node (SN) (evolved 5G base station, i.e., a 5G base station is connected to the 4G core network through the 4G base station, and needs to be modified to access the 4G core network, and the modified gNB (5G base station) is the en-gNB). The eNB is connected to the EPC through a S1 interface and to the en-gNB through a X2 interface. The en-gNB can also be connected to the EPC through a S1-U interface, and can also be connected to other en-gNB through a X2-U interface.

FIG. 3 is a schematic diagram illustrating a dual connectivity network architecture according to an embodiment of the present disclosure. As shown in FIG. 3, in the dual connectivity network architecture, the core network to which the MR-DC technology is applied to connect is a 5G core (5GC).

In this network architecture, it can be divided into a NG-RAN E-UTRA-NR dual connectivity (NGEN-DC) network architecture, a NR-E-UTRA dual connectivity (NE-DC) network architecture and a NR-NR dual connectivity (NR-DC) network architecture according to different network devices accessing the 5GC.

(1) The NGEN-DC network architecture is a dual connectivity of the NG-RAN and the E-UTRA-NR, and the UE is connected to an ng-eNB (evolved 4G base station) serving as a MN and a gNB serving as a SN. The ng-eNB is connected to the 5GC, and the gNB is connected to the ng-eNB through a Xn interface.

(2) The NE-DC network architecture is a dual connectivity of the NR and the E-UTRA, and the UE is connected to a gNB serving as a MN and a ng-eNB serving as a SN. The gNB is connected to the 5GC, and the ng-eNB is connected to the gNB through a Xn interface.

(3) The NR-DC network architecture is a dual connectivity of the NR-NR, and the UE is connected to a gNB serving as a MN and a gNB serving as a SN. The master gNB is connected to the 5GC through a next generation (NG) interface, two gNBs are connected through a Xn interface, and the secondary gNB can also be connected to the 5GC through a NG-U interface.

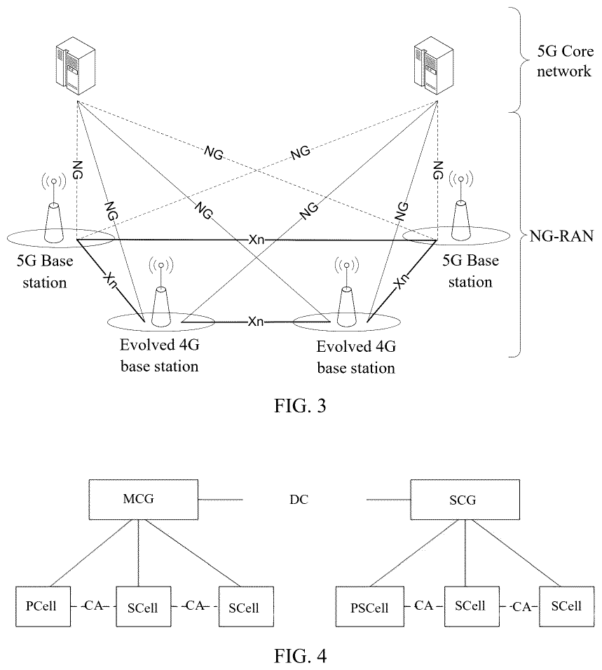

Under the dual connectivity, the UE can access two cell groups, i.e., a master cell group (MCG) and a secondary cell group (SCG). FIG. 4 is a schematic diagram illustrating a cell distribution according to an example of the present disclosure. As shown in FIG. 4, there may be a plurality of cells in the MCG, where a cell for initiating initial access is a primary cell (PCell). The PCell is the most important cell in the MCG and the first cell to which the UE is connected. The PCell in the MCG and secondary cell (SCell) in the MCG are combined through carrier aggregation (CA) to increase the signal bandwidth and thus improve the transmission bit rate. A primary secondary cell in the SCG is abbreviated as PSCell, and a secondary cell is abbreviated as SCell. In order to facilitate the resource scheduling of the network device, the network device will configure the selective activation information of the cell groups for the UE, and transmit the configuration information to the UE. The configuration information may include at least one of: identifier (ID) information of a configured cell group, activation condition information of a cell group, a to-be-activated cell group, or a to-be-activated cell. When the UE needs to perform the selective activation of the cell groups, the corresponding cell group can be selectively activated according to the configuration information, and the network device does not need to provide the configuration of the cell groups again, thus reducing the signaling overhead and the interruption time of the CG change.

In related art, conditional handover (CHO), conditional PSCell change (CPC) and conditional PSCell addition (CPA) are proposed. For the CHO/CPC/CPA, the UE must release the configuration of the CHO/CPC/CPA when completing random access to the target PCell/PSCell. Therefore, if the network device does not reconfigure and reinitialize the CHO/CPC/CPA, the UE will not be able to continue to perform the CHO/CPC/CPA. As a result, the handover or the delay of SCG change is increased and the signaling overhead is increased, therefore, the selective activation of cell groups in the MR-DC is proposed, such that the subsequent configuration can be performed even after the cell group (CG) has been changed, without the need for the network to reconfigure or reinitialize the configuration information for selective activation of the corresponding cell group. Therefore, signaling overhead and the interruption time of CG change can be reduced.

The configuration information for the selective activation of the cell groups may include at least one of: a configuration ID, an activation condition, a configuration of a to-be-activated cell group, or a configuration of a to-be-activated cell. The selective activation of the cell groups can make the subsequent configuration still be performed after the cell group is changed, without the need for the network to reconfigure or reinitialize the configuration for the selective activation of the corresponding cell group. Therefore, in the selective activation of cell groups, the network device can provide a “to-be-activated cell group” for the terminal. Subsequently, the “to-be-activated cell group” can be activated or deactivated without providing the configuration of the cell group again.

In the selective activation of cell groups, the network device can provide a pre-configured candidate target cell group or a target cell to the terminal device. Subsequently, the terminal device can activate or deactivate the pre-configured candidate cell group or cell according to the configuration (such as an activation message) issued by the network device or the corresponding activation event, without re-providing the configuration of the cell groups. Alternatively, it is to be understood that in the selective activation of cell groups, when a new cell or cell group is activated, or after applying a new cell configuration or cell group configuration, or after accessing a new cell or cell group, the terminal device will not delete the corresponding configuration information for the selective activation of the cell group.

The selective activation of cell groups can also be called cell group activation. The cell group activation allows for the execution of corresponding configuration information even after a cell group or cell change, without the need for the network to reconfigure or reinitialize the configuration information for the corresponding cell group activation. Therefore, the cell group activation can reduce signaling overhead and interruption time of cell group change. The configuration information for cell group activation may include the configuration ID and the configuration of the target cell or the configuration of the target cell group. In some embodiments, the configuration information for cell group activation may also include a trigger condition (also called execution condition and activation condition).

In an embodiment, the cell group activation is a mobility management process, which includes any configuration of cell group activation configuration. For example, the terminal device activates or deactivates the corresponding cell or cell group based on signaling sent by the network, protocol specified criteria, or terminal device autonomy, or apply the corresponding cell configuration or cell group configuration, or access the cell or cell group for mobility management.

In an embodiment, the cell group activation is a mobility management process, including any mobility management process that does not delete or release part or all of the corresponding configuration information after performing the mobility process. Not deleting or releasing the corresponding part or all of the configuration information can also be called keeping the corresponding part or all of the configuration information.

In the present disclosure, a cell group is one or more of a master cell group (MCG) and a secondary cell group (SCG). The MCG includes one or more of a primary cell (PCell) and a secondary cell (SCell). The SCG includes one or more of a primary secondary cell (PSCell) and a secondary cell (SCell).

In the present disclosure, the selective activation of cell groups may include cell selective activation or cell activation, for example, one or more of PCell activation, PSCell activation and SCell activation.

In the related art, when the network device newly allocates uplink resources to the UE for data transmission, the UE triggers the power headroom report (PHR) according to the uplink resources when the trigger condition of the PHR is met. In the dual connectivity network architecture, the UE activates and deactivates the cell group according to the configuration information of selective activation. In this process, the network device will not transmit the configuration of the cell group to the UE after transmitting the configuration of selective activation to the UE, resulting in the UE being unable to determine how to trigger PHR when the cell group changes, and which PHR information needs to be reported when PHR is triggered. Therefore, in this embodiment, the UE receives the configuration information transmitted by the network device. The configuration information includes information for configuring a candidate cell group. When the UE accesses the network through the NR-DC, the UE can receive a plurality of cell groups transmitted by the network device, and the network device allocates one or more cell groups in the cell groups as a candidate cell group according to the configuration information. The candidate cell group may include a selectively activated cell group, a selectively deactivated cell group, an activated cell group and a deactivated cell group. It is to be noted that the currently activated cell group is the currently serving cell group for the UE. The configuration information includes a selective activation condition or a selective deactivation condition of a cell group. The UE can make a determination according to the configuration information, and activate/deactivate the corresponding cell group when the activation condition or the deactivation condition is met. Through the configuration information, the UE can determine the information of the candidate cell group allocated by network device, where the information may be the ID information of the candidate cell group, etc.

In returning to FIG. 1, at step S102, it is determined, based on the configuration information, whether to perform power headroom report.

In this embodiment, after receiving the configuration information, the UE can perform the power headroom report according to the configuration information. For example, if the configuration information includes activation command information or activation condition information, when the UE receives the activation command information or activation condition information transmitted by the network device, the UE can deactivate the original activated cell group and activate the candidate cell group corresponding to the activation command information or activation condition information in the configuration information, so that the activated cell group in the UE changes, where the activated cell group is the current serving cell group for the UE. At this time, performing, through the activated cell group, the power headroom report can be triggered. It is to be noted that if the UE has no original activated cell group, that is, the UE has no activated cell group, the UE can directly activate the corresponding candidate cell group. If the configuration information includes the deactivation information for the candidate cell group, the UE can only deactivate the currently activated cell group according to the configuration information, and there is no corresponding serving cell group for the UE.

For example, when the activated candidate cell group is used to perform the power headroom report (PHR) based on the configuration information, the PHR information of the candidate cell group can be reported, and the PHR information of other candidate cell groups in the configuration information can also be reported. The PHR is used to support the scheduling of power-aware packets, and in the NR, three types of reports are supported, i.e., the first type of report is used for physical uplink shared channel (PUSCH) transmission, and the second type of report is used for PUSCH and physical uplink control channel (PUCCH) transmission in the long term evolution (LTE) cell group in the EN-DC, and the third type of report is used for sounding reference signal (SRS) transmission on the SCell that only configures the SRS. In the case of carrier aggregation (CA), when no transmission occurs on the activated SCell, a virtual report of reference power is used. In order to allow the network to detect the UL(Uplink) power reduction, the PHR may also contain power management maximum power reduction (P-MPR) information. In this embodiment, in the MR-DC architecture, each cell group is independently configured with the PHR, and an event of a cell group can trigger the power headroom report of the MCG and/or the SCG, and PHR information of a cell group can also be included in the PHR transmitted by another cell group. The PHR information may be one or more of power headroom (PH) of the PCell, PH of the PSCell and PH of the SCell. The UE can report the PHR information according to a media access control element (MAC CE) after triggering the power headroom report according to the configuration information.

In some embodiments, the candidate cell group includes at least one of: a master cell group (MCG), a secondary cell group (SCG), a primary cell (PCell), a primary secondary cell (PSCell), or a secondary cell (Scell).

In the embodiment, the candidate cell group may be the master cell group, or the secondary cell group in the MR-DC network architecture, and the candidate cell group may include a plurality of cells. The candidate cell group may also be a single cell in the master cell group including a primary cell or a secondary cell, or a single cell in the secondary cell group including a primary secondary cell or a secondary cell, which is not limited in the embodiment.

Through the solution, the UE can determine whether to report the power headroom based on the configuration information, and the way of triggering the power headroom report by the UE and the type of the PHR information are determined, so that the network device can assist in the scheduling of uplink resources according to the PHR information reported by the UE.

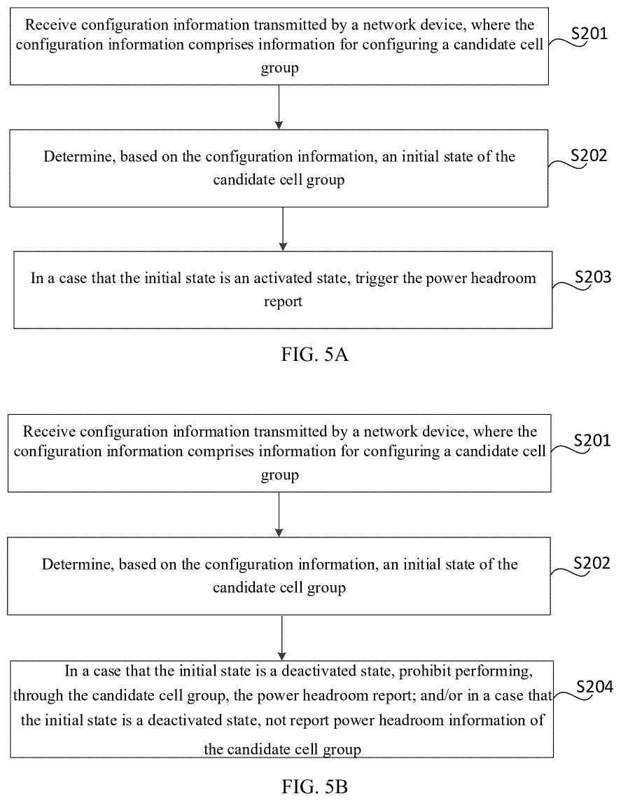

FIGS. 5A and 5B is a flowchart illustrating a method for reporting power headroom information according to an embodiment of the present disclosure. As shown in FIGS. 5A and 5B, the method is performed by a UE, and includes the following step S201.

At step S201, configuration information transmitted by a network device is received, where the configuration information includes information for configuring a candidate cell group.

For example, the way of receiving the configuration information in this embodiment is the same as that in the step S101, which can be referred to and will not be repeated.

In an embodiment, as shown in FIG. 5A, the UE determining, based on the configuration information, whether to report the power headroom may include the following steps S202 and S203.

At step S202, an initial state of the candidate cell group is determined based on the configuration information.

At step S203, in a case that the initial state is an activated state, the power headroom report is triggered.

For example, the way of the UE determining the candidate cell group based on the configuration information in this embodiment is the same as that in the step S101, which can be referred to and will not be repeated. After the UE determines the candidate cell group, it is determined that the initial state of the candidate cell group in the UE, and if the initial state is an activated state, the power headroom report is performed through the candidate cell group. In another implementation, as shown in FIG. 5B, after step S202, the method further includes step S204, that is, determining whether to perform the power headroom report may include previously described step S202 and the following step S204.

At step S204, in a case that the initial state is a deactivated state, performing, through the candidate cell group, the power headroom report is prohibited; and/or in a case that the initial state is a deactivated state, the power headroom information of the candidate cell group is not reported.

For example, when the information for configuring the selectively activated candidate cell group is received, if the initial state of the cell group is a deactivated state, the power headroom report is not triggered, otherwise the power headroom report is triggered.

In an embodiment, when a cell group is configured or added, if the initial state of the cell group is a deactivated state, the power headroom report is not triggered, otherwise the power headroom report is triggered.

For example, when the UE receives the configuration information containing the candidate cell group, and the corresponding cell group configuration information is applied. If the candidate cell group is not activated when the candidate cell group is configured, the UE will not trigger the PHR even if the trigger condition for the power headroom report is met.

For example, when the UE receives the configuration information of the candidate cell group, and the corresponding cell group configuration information is applied, even if the PHR is configured or reconfigured, the PHR will be not triggered.

For example, when the UE receives the configuration information containing the candidate cell group, and the corresponding cell group configuration information is applied. If the candidate cell group is configured, the cell group is activated, and the UE triggers the PHR.

For example, in the embodiment, when it is determined that the initial state of the candidate cell group in the UE is a deactivated state, it means that the network device configures the UE to close the resource of the candidate cell. The UE cannot perform, through the candidate cell group, the power headroom report, and the network device can determine the PHR information of the candidate cell group according to the deactivated state of the candidate cell group. Therefore, in the case that the initial state of the candidate cell group is a deactivated state, the UE is controlled to not perform, through the candidate cell group, the power headroom report; and/or, in the case that the initial state of the candidate cell group is a deactivated state, when other candidate cells perform the power headroom report, the PHR information of the candidate cell group is not reported. In the embodiment, when the initial state of the candidate cell group is a deactivated state, even if the PHR trigger condition is reconfigured in the configuration information, the power headroom report is not triggered.

Through the solution, the UE can determine whether to perform the power headroom report based on the initial state of the candidate cell group (an activated state or a deactivated state), and the way of triggering the power headroom report by the UE is determined, so that the network device can assist in the scheduling of uplink resources according to the PHR information reported by the UE.

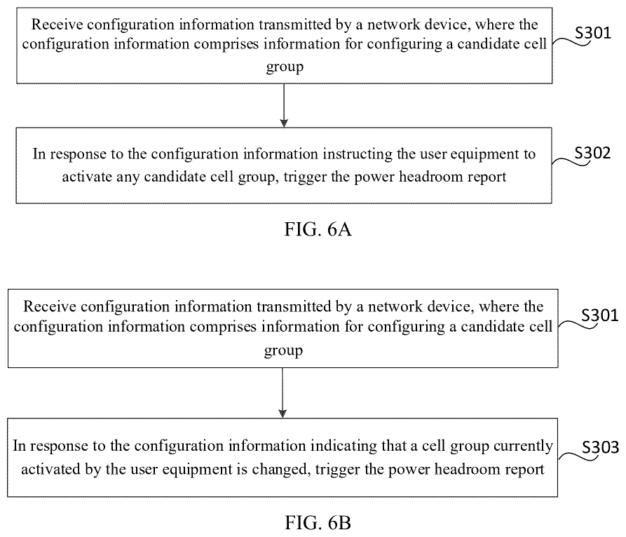

FIGS. 6A and 6B is a flowchart illustrating a method for reporting power headroom information according to an embodiment of the present disclosure. As shown in FIGS. 6A and 6B, the method is performed by a UE, and includes the following step S301.

At step S301, configuration information transmitted by a network device is received, where the configuration information includes information for configuring a candidate cell group.

For example, the way of receiving the configuration information in this embodiment is the same as that in the step S101, which can be referred to and will not be repeated.

In an embodiment, the UE determining, based on the configuration information, whether to report the power headroom may include at least one of: step S302 or step S303.

At step S302, in response to the configuration information instructing the user equipment to activate any candidate cell group, the power headroom report is triggered, as shown in FIG. 6A.

At step S303, in response to the configuration information indicating that a cell group currently activated by the user equipment is changed, the power headroom report is triggered, as shown in FIG. 6B.

In an embodiment, when the cell group is deactivated, the power headroom report is not triggered.

For example, when the cell group for the UE is deactivated, even if the existing PHR trigger condition is met (for example, the PHR period timer expires), the UE does not perform the power headroom report.

In an embodiment, when a certain candidate cell group is selectively activated, the power headroom report is triggered.

In an embodiment, when the UE activates any candidate cell group, the power headroom report is triggered.

In an embodiment, when the cell group is changed, the power headroom report is triggered.

For example, when the currently activated cell group of the UE is changed, for example, from the activated cell group 1 to the activated cell group 2, the power headroom report is triggered.

For example, in the embodiment, the configuration information includes an activation command or an activation configuration condition for activating any candidate cell group. When the UE determines that there is an activated or selectively activated candidate cell group in the candidate cell groups according to the configuration information, it is determined that it is necessary to perform the power headroom report, and the power headroom report is triggered when any candidate cell group is activated; and/or, after receiving the configuration information, the UE detects the currently activated cell group in the UE, and if the currently activated cell group is changed, for example, when the activated primary cell is changed from a cell A to a cell B, the power headroom report is triggered.

Through the solution, the UE can detect the cell group and/or the candidate cell group according to the configuration information, and when the cell group is changed and/or the candidate cell group is activated, the power headroom report is triggered. The way of triggering the power headroom report by the UE is determined, so that the network device can assist in the scheduling of uplink resources according to the PHR information reported by the UE.

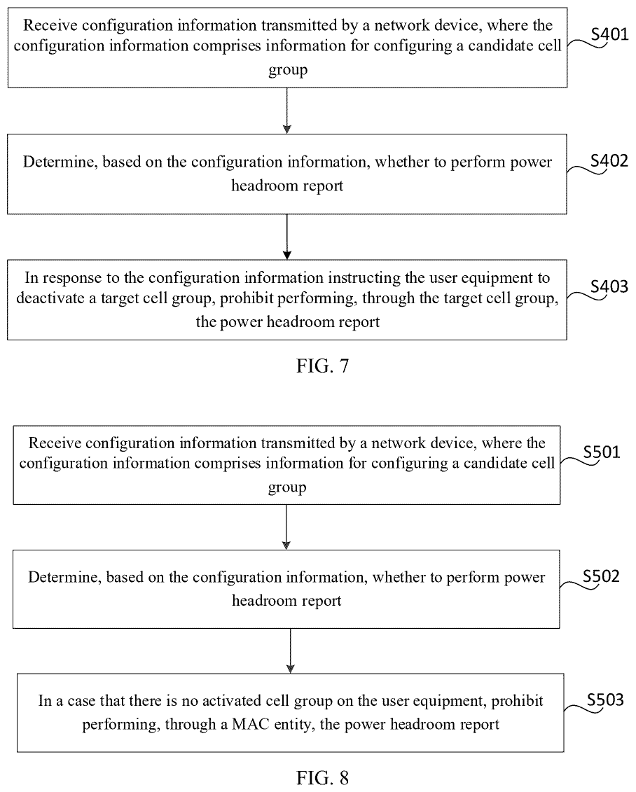

FIG. 7 is a flowchart illustrating a method for reporting power headroom information according to an embodiment of the present disclosure. As shown in FIG. 7, the method is performed by a UE, and includes the following steps S401 to S402.

At step S401, configuration information transmitted by a network device is received, where the configuration information includes information for configuring a candidate cell group.

For example, the way of receiving the configuration information in this embodiment is the same as that in the step S101, which can be referred to and will not be repeated.

At step S402, it is determined, based on the configuration information, whether to perform power headroom report.

For example, the way of performing the power headroom report in this embodiment is the same as that in the step S102, which can be referred to and will not be repeated.

In an embodiment, after step S402, the method further includes step S403.

At step S403, in response to the configuration information instructing the user equipment to deactivate a target cell group, performing, through the target cell group, the power headroom report is prohibited.

For example, in the embodiment, the candidate cell may include a deactivated candidate cell group. The deactivated candidate cell group is a target cell group, and the UE detects the target cell group through the configuration information, and stops performing, through the target cell group, the power headroom report when the target cell group is deactivated. For example, the currently activated cell group can also be detected by the UE. When the UE deactivates any activated cell group through relevant information, the deactivated cell group is the target cell group, and performing, through the target cell group, the power headroom report is prohibited.

Through the solution, the UE detects the deactivated cell group, and stops, when the cell group is deactivated, performing, through the deactivated cell group, the power headroom report. Thus, the way for the UE to stop triggering the power headroom report is clarified, and the signaling overhead is reduced.

FIG. 8 is a flowchart illustrating a method for reporting power headroom information according to an embodiment of the present disclosure. As shown in FIG. 8, the method is performed by a UE, and includes the following steps S501 to S502.

At step S501, configuration information transmitted by a network device is received, where the configuration information includes information for configuring a candidate cell group.

For example, the way of receiving the configuration information in this embodiment is the same as that in the step S101, which can be referred to and will not be repeated.

At step S502, it is determined, based on the configuration information, whether to perform power headroom report.

For example, the way of performing the power headroom report in this embodiment is the same as that in the step S102, which can be referred to and will not be repeated.

In an embodiment, after step S502, the method further includes step S503.

At step S503, in a case that there is no activated cell group on the user equipment, performing, through a media access control (MAC) entity, the power headroom report is prohibited.

In the embodiment, the UE detects the activation state of the cell group, and when there is no activated cell group on the UE, performing, through the MAC entity, the power headroom report is prohibited. For example, the cell group can be the MCG, and when the UE does not have an activated MCG, at this time, performing, through the corresponding MAC entity of the MCG, the power headroom report is prohibited. The cell group can also be the SCG, and when there are no activated PSCell and SCell in the SCG cell group of the UE, it means that the SCG is in a deactivated state, performing, through the corresponding MAC entity of the SCG, the power headroom report is prohibited.

Through the solution, when the UE determines that there is no activated cell group on the UE through detection, performing, through the MAC entity, the power headroom report is prohibited. Thus, Thus, the way for the UE to stop triggering the power headroom report is clarified, and the signaling overhead is reduced.

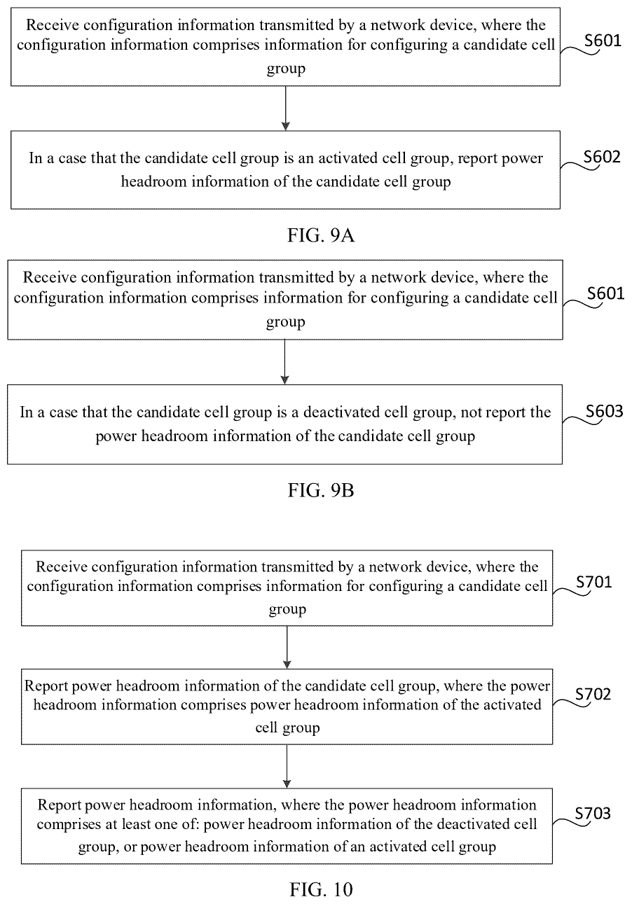

FIGS. 9A and 9B is a flowchart illustrating a method for reporting power headroom information according to an embodiment of the present disclosure. As shown in FIGS. 9A and 9B, the method is performed by a UE, and includes the following step S601.

At step S601, configuration information transmitted by a network device is received, where the configuration information includes information for configuring a candidate cell group.

For example, the way of receiving the configuration information in this embodiment is the same as that in the step S101, which can be referred to and will not be repeated.

After step S601, the method may include at least one of: step S602 or step S603.

In an embodiment, as shown in FIG. 9A, performing, by the UE based on the configuration information, the power headroom report may include the following step S602.

At step S602, in a case that the candidate cell group is an activated cell group, the power headroom information of the candidate cell group is reported.

For example, in the embodiment, the activated state of the candidate cell group is determined by the configuration information, and when the candidate cell group in the configuration information is an activated cell group, the power headroom report is triggered, and the PHR information of the candidate cell group is reported.

In another embodiment, as shown in FIG. 9B, the method further includes step S603.

At step S603, in a case that the candidate cell group is a deactivated cell group, the power headroom information of the candidate cell group is not reported.

For example, in the embodiment, the deactivated state of the candidate cell group is determined by the configuration information, and when the candidate cell group in the configuration information is a deactivated cell group, the PHR information of the candidate cell group is not reported.

Through the solution, the UE can determine whether to report the PHR information of the candidate cell group based on the state of the candidate cell group, thereby clarifying which PHR information the UE needs to report, enabling the network device to assist in scheduling uplink resources based on the reported PHR information.

FIG. 10 is a flowchart illustrating a method for reporting power headroom information according to an embodiment of the present disclosure. As shown in FIG. 10, the method is performed by a UE, and includes the following step S701.

At step S701, configuration information transmitted by a network device is received, where the configuration information includes information for configuring a candidate cell group.

For example, the way of receiving the configuration information in this embodiment is the same as that in the step S101, which can be referred to and will not be repeated.

In an embodiment, the candidate cell group includes an activated cell group, and performing, by the UE based on the configuration information, the power headroom report may include the following step S702.

At step S702, the power headroom information of the candidate cell group is reported, where the power headroom information includes power headroom information of the activated cell group.

For example, in the embodiment, when the UE determines, based on the configuration information, that there is an activated cell group in the candidate cell group, the power headroom report is triggered, where the reported PHR information includes the PHR information of the activated cell group.

In another embodiment, the candidate cell group includes a deactivated cell group, and performing, by the UE based on the configuration information, the power headroom report may include the following step S703.

At step S703, power headroom information is reported, where the power headroom information includes at least one of: power headroom information of the deactivated cell group, or power headroom information of the activated cell group.

For example, in the embodiment, the UE determines, based on the configuration information, that there is a deactivated cell group in the candidate cell group, and when the power headroom report is triggered, the reported PHR information includes at least one of: the PHR information of the activated cell group, or the PHR information of other activated cell groups.

For example, when the PHR is performed, the power headroom information of the activated candidate cell group is included.

For example, when the PHR is performed, the power headroom information of the non-activated candidate cell group is included.

For example, in a dual connectivity, the MAC entity of the MCG or SCG may include power headroom information for the currently activated and/or deactivated MCG and/or SCG.

For example, the candidate cell group includes the currently activated cell group or the deactivated candidate cell group.

It is to be noted that the power headroom information of a cell group can be one or more of: power headroom of the PCell, power headroom of the PSCell, and power headroom of the SCell.

For example, the UE can report the power headroom information through the MAC CE.

Through the solution, the UE determines the activated and/or deactivated cell groups in the candidate cell groups based on the configuration information. When the power headroom report is triggered, the PHR information of the activated cell group and/or the PHR information of the deactivated cell group are/is reported, and the PHR information that needs to be reported when the UE triggers the power headroom report is determined, such that the network device can assist in scheduling uplink resources based on the PHR information reported by the UE.

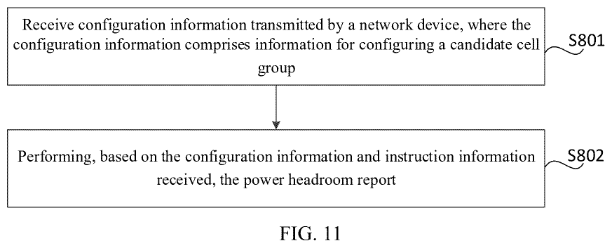

FIG. 11 is a flowchart illustrating a method for reporting power headroom information according to an embodiment of the present disclosure. As shown in FIG. 11, the method is performed by a UE, and includes the following step S801.

At step S801, configuration information transmitted by a network device is received, where the configuration information includes information for configuring a candidate cell group.

For example, the way of receiving the configuration information in this embodiment is the same as that in the step S101, which can be referred to and will not be repeated.

In an embodiment, performing, by the UE based on the configuration information, the power headroom report may include the following step S802.

At step S802, the power headroom report is performed based on the configuration information and instruction information received.

In the embodiment, after the power headroom report is triggered based on the configuration information, the instruction information transmitted by the network device indicates whether the UE needs to report the PHR information of the candidate cell after the PHR is triggered. The PHR information may include the power headroom (PH) information of the activated candidate cell and/or the PH information of the deactivated candidate cell. The UE performs the power headroom report based on the PHR information to be reported as indicated by this instruction message.

In some embodiments, the instruction information may include RRC information or MAC CE information.

For example, the instruction information in the embodiment may be RRC information or MAC CE information, and the network device indicates to the UE whether the PHR information of the candidate cell group needs to be reported via the RRC information or MAC CE information.

In another embodiments, the configuration information includes instruction information, and performing, by the UE based on the received instruction information, the power headroom report includes: performing, based on the instruction information in the configuration information, the power headroom report.

For example, in the embodiment, the configuration information may include instruction information for indicating which PHR information the UE reports. After the UE triggers the power headroom report, the power headroom report is performed according to the instruction information in the configuration information.

In another embodiments, the configuration information may include a power headroom report configuration, and performing, by the UE based on the received instruction information, the power headroom report includes: in response to the configuration information being configured for activating the candidate cell group, in a case that the candidate cell group is activated based on the configuration information, reporting, based on the power headroom report configuration and the instruction information, power headroom information of the candidate cell group.

For example, in the embodiment, when the UE activates a candidate cell, the corresponding power headroom report can be performed according to the PHR configuration information and the instruction information contained in the configuration information of the corresponding candidate cell group.

For example, it can be determined, based on the instruction information, whether to report the PHR information of the candidate cell group. For example, the instruction information can include one or more of the following four instructions.

(1) The instruction information is configured to indicate whether to report the PHR information of the activated cell group of the MAC entity, for example, to indicate whether to report the PH of the SPCell/SCell of the activated cell group corresponding to the configuration information of the MAC entity.

(2) The instruction information is configured to indicate whether to report the PHR information of the deactivated cell group of the MAC entity, for example, to indicate whether to report the PH of the SPCell/SCell of the deactivated cell group corresponding to the configuration information of the MAC entity.

(3) The instruction information is configured to indicate whether to report the PHR information of the activated cell group of other MAC entity, for example, to indicate whether to report the PH of the SPCell/SCell of the activated cell group of other MAC entity.

(4) The instruction information is configured to indicate whether to report the PHR information of the deactivated cell group of other MAC entity, for example, to indicate whether to report the PH of the SPCell/SCell of the deactivated cell group of other MAC entity.

The instruction information can indicate whether to report the PHR information of the candidate cell group through RRC (or MAC CE) information. For example, the instruction information can be included in the configuration information for the corresponding cell group, for example, the instruction information can be included in MAC-CellGroupConfig, or phr-Config; alternatively, when the UE activates a candidate cell group, the corresponding power headroom is reported based on the PHR related configuration information and instruction information included in the configuration information for the corresponding candidate cell group.

Through the solution, the UE determines, based on the instruction information transmitted by the network device, whether to report the PHR information of the candidate cell group. The PHR information to be reported is determined when the UE triggers the power headroom report, so that the network device can assist in the scheduling of uplink resources according to the PHR information reported by the UE.

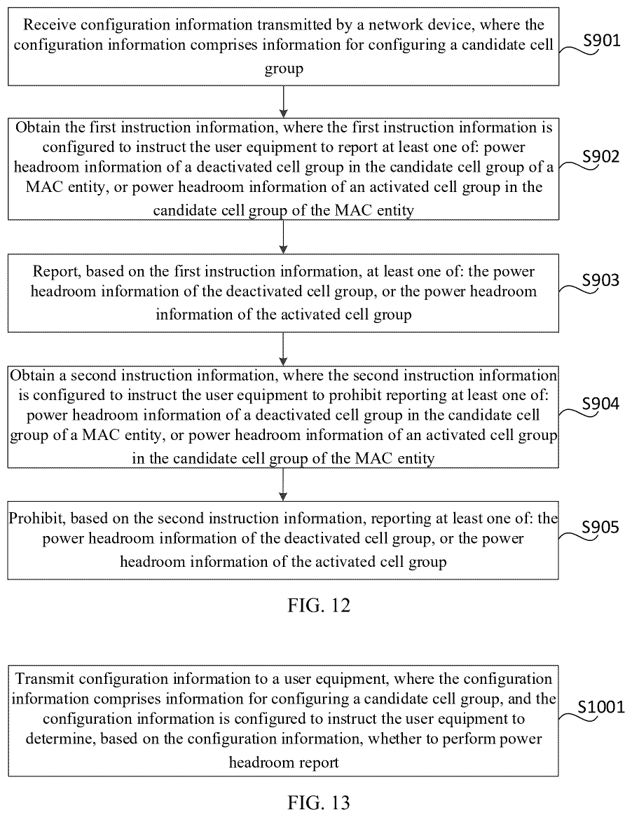

FIG. 12 is a flowchart illustrating a method for reporting power headroom information according to an embodiment of the present disclosure. As shown in FIG. 12, the method is performed by a UE, and includes the following step S901.

At step S901, configuration information transmitted by a network device is received, where the configuration information includes information for configuring a candidate cell group.

For example, the way of receiving the configuration information in this embodiment is the same as that in the step S101, which can be referred to and will not be repeated.

In an embodiment, performing, by the UE based on the configuration information, the power headroom report may include performing, based on the received instruction information, the power headroom report.

In an embodiment, the instruction information is first instruction information, and performing the power headroom report may include the following steps S902 and S903.

At step S902, the first instruction information is obtained, where the first instruction information is configured to instruct the user equipment to report at least one of: power headroom information of a deactivated cell group in the candidate cell group of a MAC entity, or power headroom information of an activated cell group in the candidate cell group of the MAC entity.

At step S903, at least one of: the power headroom information of the deactivated cell group, or the power headroom information of the activated cell group is report based on the first instruction information.

For example, in the embodiment, the network device transmits the first instruction information to instruct the UE to report the PHR information of the deactivated cell group in the candidate cell group of the corresponding MAC entity and/or the PHR information of the activated cell group of the corresponding MAC entity when the power headroom report is triggered.

In some embodiments, the MAC entity is a MAC entity transmitting the configuration information or another MAC entity.

In the embodiment, the UE accesses the network through the MR-DC, and establishes communication connections with two network devices. Each network device can transmit configuration information to instruct the UE to perform the power headroom report. When the UE receives the configuration information, the power headroom report is triggered. In the embodiment, when the UE reports the PHR information of the activated cell group and/or deactivated cell group of the MAC entity, the MAC entity can be the MAC entity corresponding to the configuration information or other MAC entities.

In another embodiment, the method further includes the following steps S904 and S905.

At step S904, a second instruction information is obtained, where the second instruction information is configured to instruct the user equipment to prohibit reporting at least one of: power headroom information of a deactivated cell group in the candidate cell group of a MAC entity, or power headroom information of an activated cell group in the candidate cell group of the MAC entity.

At step S905, reporting at least one of: the power headroom information of the deactivated cell group, or the power headroom information of the activated cell group is prohibited based on the second instruction information.

For example, in the embodiment, the network device transmits the second instruction information to instruct the UE to not report the PHR information of the deactivated cell group in the candidate cell group of the MAC entity corresponding to the network device and/or the PHR information of the activated cell group of the MAC entity corresponding to the network device when the power headroom report is triggered.

Through the solution, the UE determines, based on the instruction information transmitted by the network device, whether it is necessary to report the PHR information of the candidate cell group corresponding to the MAC entity or other MAC entities. The PHR information to be reported is determined when the UE triggers the power headroom report, so that the network device can assist in the scheduling of uplink resources according to the PHR information reported by the UE.

FIG. 13 is a flowchart illustrating a method for reporting power headroom information according to an embodiment of the present disclosure. As shown in FIG. 13, the method is performed by a network device, and includes the following step S1001.

At step S1001, configuration information is transmitted to a user equipment, where the configuration information includes information for configuring a candidate cell group, and the configuration information is configured to instruct the user equipment to determine, based on the configuration information, whether to perform the power headroom report.

For example, in the embodiment, the network device can be a 4G network device and/or a 5G network device, as well as an evolved 4G network device and/or an evolved 5G network device. The way of transmitting the instruction information to the UE to allow the UE to perform, based on the instruction information, the power headroom report is the same as that in the step S102, which can be referred to and will not be repeated.

In some embodiments, the candidate cell group includes at least one of: a master cell group (MCG), a secondary cell group (SCG), a primary cell (PCell), a primary secondary cell (PSCell), or a secondary cell (SCell).

For example, the definition of the candidate cell group in this embodiment is the same as that in the step S102, which can be referred to and will not be repeated.

Through the solution, the network device transmits the configuration information to the UE, such that the UE can report the power headroom based on the configuration information, and the way of triggering the power headroom report by the UE and the type of the PHR information are determined, so that the network device can assist in the scheduling of uplink resources according to the PHR information reported by the UE.

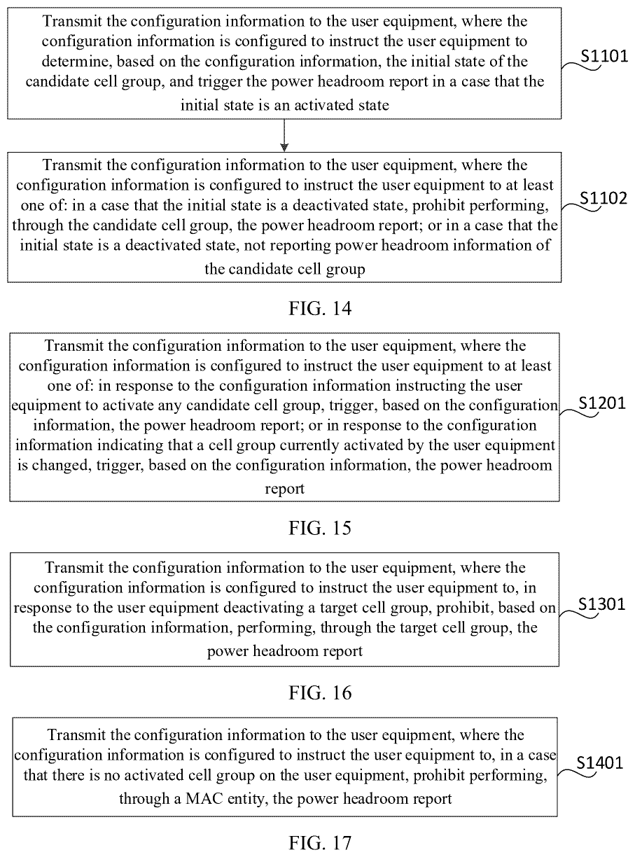

FIG. 14 is a flowchart illustrating a method for reporting power headroom information according to an embodiment of the present disclosure. As shown in FIG. 14, the method is performed by a network device, and includes the following step S1101.

At step S1101, the configuration information is transmitted to the user equipment, where the configuration information is configured to instruct the user equipment to determine, based on the configuration information, the initial state of the candidate cell group, and trigger the power headroom report in a case that the initial state is an activated state.

For example, in the embodiment, the way of transmitting the configuration information to the UE to allow the UE to perform, based on the configuration information, the power headroom report is the same as that in the step S203, which can be referred to and will not be repeated.

In another embodiment, transmitting the configuration information may further include step S1102.

At step S1102, the configuration information is transmitted to the user equipment, where the configuration information is configured to instruct the user equipment to at least one of: in a case that the initial state is a deactivated state, prohibit performing, through the candidate cell group, the power headroom report; or in a case that the initial state is a deactivated state, not report the power headroom information of the candidate cell group.

For example, in the embodiment, the way of transmitting the configuration information to the UE to allow the UE to perform, based on the configuration information, the power headroom report is the same as that in the step S204, which can be referred to and will not be repeated.

Through the solution, the network device transmits the configuration information to the UE, such that the UE can determine whether to trigger the PHR based on the initial state of the candidate cell group (an activated state or a deactivated state), and the way of triggering the power headroom report by the UE is determined, so that the network device can assist in the scheduling of uplink resources according to the PHR information reported by the UE.

FIG. 15 is a flowchart illustrating a method for reporting power headroom information according to an embodiment of the present disclosure. As shown in FIG. 15, the method is performed by a network device, and includes the following step S1201.

At step S1201, the configuration information is transmitted to the user equipment, where the configuration information is configured to instruct the user equipment to at least one of: in response to the configuration information instructing the user equipment to activate any candidate cell group, trigger, based on the configuration information, the power headroom report; or in response to the configuration information indicating that a cell group currently activated by the user equipment is changed, trigger, based on the configuration information, the power headroom report.

For example, in the embodiment, the way of transmitting the configuration information to the UE to allow the UE to perform, based on the configuration information, the power headroom report is the same as that in the steps S302 and S303, which can be referred to and will not be repeated.

Through the solution, the network device transmits the configuration information to the UE, such that the UE can detect the cell group and/or the candidate cell group according to the configuration information, and when the cell group is changed and/or the candidate cell group is activated, the power headroom report is triggered. The way of triggering the power headroom report by the UE is determined, so that the network device can assist in the scheduling of uplink resources according to the PHR information reported by the UE.

FIG. 16 is a flowchart illustrating a method for reporting power headroom information according to an embodiment of the present disclosure. As shown in FIG. 16, the method is performed by a network device, and includes the following step S1301.

At step S1301, the configuration information is transmitted to the user equipment, where the configuration information is configured to instruct the user equipment to, in response to the user equipment deactivating a target cell group, prohibit, based on the configuration information, performing, through the target cell group, the power headroom report.

For example, in the embodiment, the way of transmitting the configuration information to the UE to allow the UE to perform, based on the configuration information, the power headroom report is the same as that in the step S403, which can be referred to and will not be repeated.

Through the solution, the network device transmits the configuration information to the UE, such that the UE detects the deactivated cell group, and stops, when the cell group is deactivated, performing, through the deactivated cell group, the power headroom report. Thus, the way for the UE to stop triggering the power headroom report is clarified, and the signaling overhead is reduced.

FIG. 17 is a flowchart illustrating a method for reporting power headroom information according to an embodiment of the present disclosure. As shown in FIG. 17, the method is performed by a network device, and includes the following step S1401.

At step S1401, the configuration information is transmitted to the user equipment, where the configuration information is configured to instruct the user equipment to, in a case that there is no activated cell group on the user equipment, prohibit performing, through a media access control (MAC) entity, the power headroom report.

For example, in the embodiment, the way of transmitting the configuration information to the UE to allow the UE to perform, based on the configuration information, the power headroom report is the same as that in the step S503, which can be referred to and will not be repeated.

Through the solution, the network device transmits the configuration information to the UE, and when the UE determines that there is no activated cell group on the UE through detection, performing, through the MAC entity, the power headroom report is prohibited. Thus, Thus, the way for the UE to stop triggering the power headroom report is clarified, and the signaling overhead is reduced.

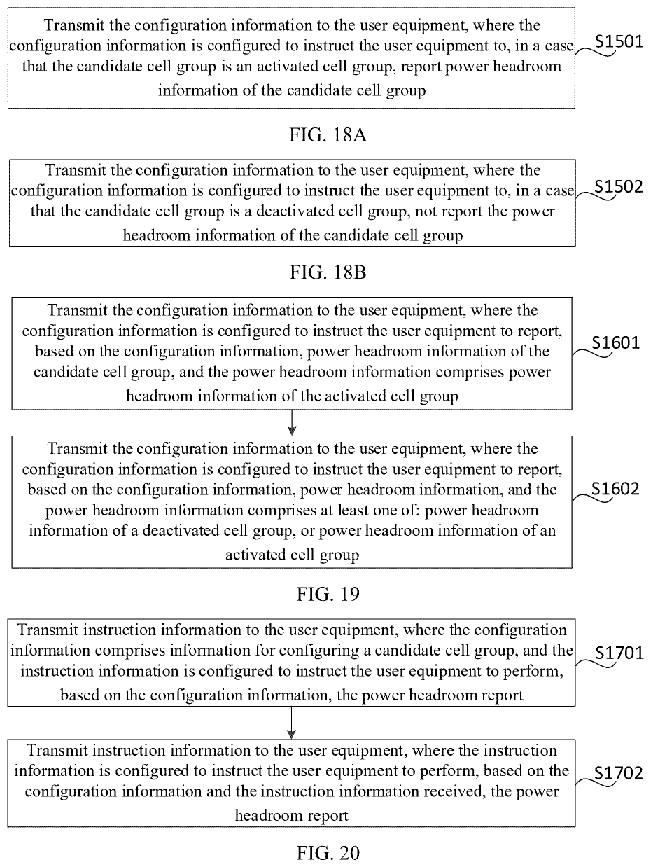

FIGS. 18A and 18B are a flowchart illustrating a method for reporting power headroom information according to an embodiment of the present disclosure. The method is performed by a network device.

In an embodiment, as shown in FIG. 18A, the method includes the following step S1501.

At step S1501, the configuration information is transmitted to the user equipment, where the configuration information is configured to instruct the user equipment to, in a case that the candidate cell group is an activated cell group, report power headroom information of the candidate cell group.

For example, in the embodiment, the way of transmitting the configuration information to the UE to allow the UE to perform, based on the configuration information, the power headroom report is the same as that in the step S602, which can be referred to and will not be repeated.

In another embodiment, as shown in FIG. 18B, the method includes step S1502.

At step S1502, transmit the configuration information to the user equipment, where the configuration information is configured to instruct the user equipment to, in a case that the candidate cell group is a deactivated cell group, not report the power headroom information of the candidate cell group.

For example, in the embodiment, the way of transmitting the configuration information to the UE to allow the UE to perform, based on the configuration information, the power headroom report is the same as that in the step S603, which can be referred to and will not be repeated.

Through the solution, the network device transmits the configuration information to the UE, and the UE can determine whether to report the PHR information of the candidate cell group based on the state of the candidate cell group, thereby clarifying which PHR information the UE needs to report, enabling the network device to assist in scheduling uplink resources based on the reported PHR information.

FIG. 19 is a flowchart illustrating a method for reporting power headroom information according to an embodiment of the present disclosure. As shown in FIG. 19, the method is performed by a network device, the candidate cell group includes an activated cell group and/or a deactivated cell group, and the method includes the following step S1601.

At step S1601, the configuration information is transmitted to the user equipment, where the configuration information is configured to instruct the user equipment to report, based on the configuration information, power headroom information of the candidate cell group, and the power headroom information includes power headroom information of the activated cell group.

For example, in the embodiment, the way of transmitting the configuration information to the UE to allow the UE to perform, based on the configuration information, the power headroom report is the same as that in the step S702, which can be referred to and will not be repeated.

In another embodiment, the method further includes step S1602.

At step S1602, the configuration information is transmitted to the user equipment, where the configuration information is configured to instruct the user equipment to report, based on the configuration information, power headroom information, and the power headroom information includes at least one of: power headroom information of a deactivated cell group, or power headroom information of an activated cell group.

For example, in the embodiment, the way of transmitting the configuration information to the UE to allow the UE to perform, based on the configuration information, the power headroom report is the same as that in the step S703, which can be referred to and will not be repeated.

Through the solution, the UE determines the activated and/or deactivated cell groups in the candidate cell groups based on the configuration information. When the power headroom report is triggered, the PHR information of the activated cell group and/or the PHR information of the deactivated cell group are/is reported, and the PHR information that needs to be reported when the UE triggers the power headroom report is determined, such that the network device can assist in scheduling uplink resources based on the power headroom information reported by the UE.

FIG. 20 is a flowchart illustrating a method for reporting power headroom information according to an embodiment of the present disclosure. As shown in FIG. 20, the method is performed by a network device, and includes the following step S1701.

At step S1701, configuration information is transmitted to a user equipment, where the configuration information includes information for configuring a candidate cell group, and the configuration information is configured to instruct the user equipment to perform, based on the configuration information, the power headroom report.

For example, the step of transmitting the configuration information in this embodiment is the same as that in the step S1001, which can be referred to and will not be repeated.

In another embodiment, the method further includes step S1702.

At step S1702, instruction information is transmitted to the user equipment, where the instruction information is configured to instruct the user equipment to perform, based on the configuration information and the instruction information received, the power headroom report.

For example, in the embodiment, the way of transmitting the instruction information to the UE to allow the UE to perform, based on the instruction information, the power headroom report is the same as that in the step S802, which can be referred to and will not be repeated.

In some embodiments, the instruction information may include RRC information or MAC CE information.

For example, the definition of the instruction information in this embodiment is the same as that in the step S802, which can be referred to and will not be repeated.

In another embodiment, the configuration information includes instruction information, and transmitting the instruction information by the network device includes: transmitting the configuration information, where the configuration information is configured to instruct the user equipment to perform, based on the instruction information in the configuration information, the power headroom report.

For example, in the embodiment, the network device transmits the configuration information to the UE, and the configuration information includes instruction information for indicating which PHR information the UE reports. After the UE triggers the power headroom report, the power headroom report is performed according to the instruction information in the configuration information.

In another embodiment, the configuration information includes a power headroom report configuration, and transmitting the instruction information includes: transmitting the instruction information, where the instruction information is configured to instruct the user equipment to: in response to the configuration information being configured for activating the candidate cell group, in a case that the candidate cell group is activated based on the configuration information, report, based on the power headroom report configuration and the instruction information, power headroom information of the candidate cell group.

For example, in the embodiment, when the UE activates a candidate cell, the corresponding power headroom report can be performed according to the PHR configuration information and the instruction information contained in the configuration information of the corresponding candidate cell group.

Through the solution, the UE determines, based on the instruction information transmitted by the network device, whether to report the PHR information of the candidate cell group. The PHR information to be reported is determined when the UE triggers the power headroom report, so that the network device can assist in the scheduling of uplink resources according to the PHR information reported by the UE.

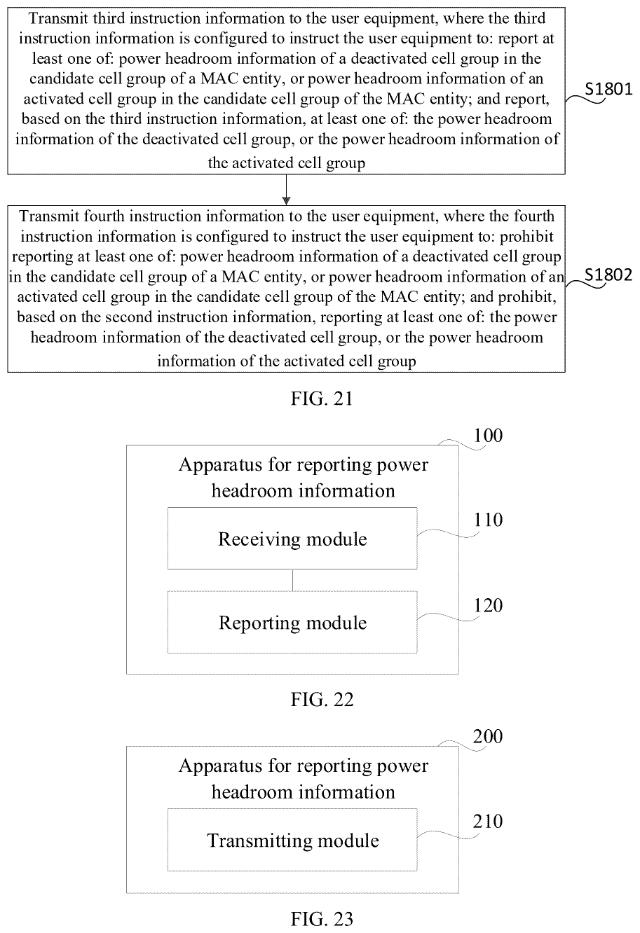

FIG. 21 is a flowchart illustrating a method for reporting power headroom information according to an embodiment of the present disclosure. As shown in FIG. 21, the method is performed by a network device, and includes the following step S1801.

At step S1801, third instruction information is transmitted to the user equipment, where the third instruction information is configured to instruct the user equipment to: report at least one of: power headroom information of a deactivated cell group in the candidate cell group of a MAC entity, or power headroom information of an activated cell group in the candidate cell group of the MAC entity; and report, based on the third instruction information, at least one of: the power headroom information of the deactivated cell group, or the power headroom information of the activated cell group.

For example, in the embodiment, the way of transmitting the instruction information to the UE to allow the UE to perform, based on the instruction information, the power headroom report is the same as that in the steps S902 and S903, which can be referred to and will not be repeated.

In some embodiments, the MAC entity is a MAC entity transmitting the configuration information or another MAC entity.

In another embodiment, the method further includes step S1802.

At step S1802, fourth instruction information is transmitted to the user equipment, where the fourth instruction information is configured to instruct the user equipment to: prohibit reporting at least one of: power headroom information of a deactivated cell group in the candidate cell group of a MAC entity, or power headroom information of an activated cell group in the candidate cell group of the MAC entity; and prohibit, based on the fourth instruction information, reporting at least one of: the power headroom information of the deactivated cell group, or the power headroom information of the activated cell group.

For example, in the embodiment, the way of transmitting the instruction information to the UE to allow the UE to perform, based on the instruction information, the power headroom report is the same as that in the steps S904 and S905, which can be referred to and will not be repeated.

Through the solution, the network device transmits the instruction information to the UE, and the UE determines, based on the instruction information transmitted by the network device, whether it is necessary to report the PHR information of the candidate cell group corresponding to the MAC entity or other MAC entities. The PHR information to be reported is determined when the UE triggers the power headroom report, so that the network device can assist in the scheduling of uplink resources according to the PHR information reported by the UE.

FIG. 22 is a structural schematic diagram illustrating an apparatus for reporting power headroom information according to another embodiment of the present disclosure. As shown in FIG. 22, the apparatus 100 is applied to a user equipment, and includes a receiving module 110 and a reporting module 120.

The receiving module 110 is configured to receive configuration information transmitted by a network device, where the configuration information includes information for configuring a candidate cell group.

The reporting module 120 is configured to determine, based on the configuration information, whether to perform power headroom report.

In some embodiments, the reporting module 120 is further configured to: determine, based on the configuration information, an initial state of the candidate cell group; and in a case that the initial state is an activated state, trigger the power headroom report.

In some embodiment, the apparatus 100 further includes a first prohibition module, and the first prohibition module is configured to: in a case that the initial state is a deactivated state, prohibit performing, through the candidate cell group, the power headroom report; and/or in a case that the initial state is a deactivated state, not report the power headroom information of the candidate cell group.

In some embodiments, the reporting module 120 is further configured to: in response to the configuration information instructing the user equipment to activate any candidate cell group, trigger the power headroom report; and/or in response to the configuration information indicating that a cell group currently activated by the user equipment is changed, trigger the power headroom report.

In some embodiment, the apparatus 100 further includes a second prohibition module, and the second prohibition module is configured to: in response to the configuration information instructing the user equipment to deactivate a target cell group, prohibit performing, through the target cell group, the power headroom report.

In some embodiment, the apparatus 100 further includes a third prohibition module, and the third prohibition module is configured to: in a case that there is no activated cell group on the user equipment, prohibit performing, through a media access control (MAC) entity, the power headroom report.

In some embodiments, the reporting module 120 is further configured to: in a case that the candidate cell group is an activated cell group, report the power headroom information of the candidate cell group.

In some embodiment, the apparatus 100 further includes a fourth prohibition module, and the fourth prohibition module is configured to: in a case that the candidate cell group is a deactivated cell group, not report the power headroom information of the candidate cell group.

In some embodiments, the candidate cell group includes an activated cell group, and the reporting module 120 is further configured to: report the power headroom information of the candidate cell group, where the power headroom information includes power headroom information of the activated cell group.

In some embodiments, the candidate cell group includes a deactivated cell group, and the reporting module 120 is further configured to: report power headroom information, where the power headroom information includes at least one of: power headroom information of the deactivated cell group, or power headroom information of the activated cell group.

In some embodiments, the reporting module 120 further includes an instruction submodule.

The instruction submodule is configured to perform, based on the configuration information and instruction information received, the power headroom report.

In some embodiments, the instruction information is first instruction information, and the instruction submodule is further configured to: obtain the first instruction information, where the first instruction information is configured to instruct the user equipment to report at least one of: power headroom information of a deactivated cell group in the candidate cell group of a MAC entity, or power headroom information of an activated cell group in the candidate cell group of the MAC entity; and report, based on the first instruction information, at least one of: the power headroom information of the deactivated cell group, or the power headroom information of the activated cell group.

In some embodiment, the apparatus 100 further includes a fourth prohibition module, and the fourth prohibition module is configured to: obtain a second instruction information, where the second instruction information is configured to instruct the user equipment to prohibit reporting at least one of: power headroom information of a deactivated cell group in the candidate cell group of a MAC entity, or power headroom information of an activated cell group in the candidate cell group of the MAC entity; and prohibit, based on the second instruction information, reporting at least one of: the power headroom information of the deactivated cell group, or the power headroom information of the activated cell group.

In some embodiments, the instruction information includes: radio resource control (RRC) information or media access control control element (MAC CE) information.

In some embodiments, the configuration information includes instruction information.

In some embodiments, the configuration information includes a power headroom report configuration, and the instruction submodule is further configured to: in response to the configuration information being configured for activating the candidate cell group, in a case that the candidate cell group is activated based on the configuration information, report, based on the power headroom report configuration and the instruction information, power headroom information of the candidate cell group.

In some embodiments, the MAC entity is a MAC entity transmitting the configuration information or another MAC entity.

In some embodiments, the candidate cell group includes at least one of: a master cell group, a secondary cell group, a primary cell, a primary secondary cell, or a secondary cell.

Regarding the apparatuses in the above examples, the specific manner in which each module performs operations has been described in detail in the examples of the methods, and will not be described in detail here.

FIG. 23 is a structural schematic diagram illustrating an apparatus for reporting power headroom information according to another embodiment of the present disclosure. As shown in FIG. 23, the apparatus 200 is applied to a network device, and includes a transmitting module 210.

The transmitting module 210 is configured to transmit configuration information to a user equipment, where the configuration information includes information for configuring a candidate cell group, and the configuration information is configured to instruct the user equipment to determine, based on the configuration information, whether to perform power headroom report.

In some embodiments, the transmitting module 210 is further configured to: transmit the configuration information to the user equipment, where the configuration information is configured to instruct the user equipment to determine, based on the configuration information, the initial state of the candidate cell group, and trigger the power headroom report in a case that the initial state is an activated state.

In some embodiments, the transmitting module 210 is further configured to: transmit the configuration information to the user equipment, where the configuration information is configured to instruct the user equipment to at least one of: in a case that the initial state is a deactivated state, prohibit performing, through the candidate cell group, the power headroom report; or in a case that the initial state is a deactivated state, not report the power headroom information of the candidate cell group.

In some embodiments, the transmitting module 210 is further configured to: transmit the configuration information to the user equipment, where the configuration information is configured to instruct the user equipment to at least one of: in response to the configuration information instructing the user equipment to activate any candidate cell group, trigger, based on the configuration information, the power headroom report; or in response to the configuration information indicating that a cell group currently activated by the user equipment is changed, trigger, based on the configuration information, the power headroom report.

In some embodiments, the transmitting module 210 is further configured to: transmit the configuration information to the user equipment, where the configuration information is configured to instruct the user equipment to, in response to the user equipment deactivating a target cell group, prohibit, based on the configuration information, performing, through the target cell group, the power headroom report.

In some embodiments, the transmitting module 210 is further configured to: transmit the configuration information to the user equipment, where the configuration information is configured to instruct the user equipment to, in a case that there is no activated cell group on the user equipment, prohibit performing, through a media access control (MAC) entity, the power headroom report.

In some embodiments, the transmitting module 210 is further configured to: transmit the configuration information to the user equipment, where the configuration information is configured to instruct the user equipment to, in a case that the candidate cell group is an activated cell group, report power headroom information of the candidate cell group.

In some embodiments, the transmitting module 210 is further configured to: transmit the configuration information to the user equipment, where the configuration information is configured to instruct the user equipment to, in a case that the candidate cell group is a deactivated cell group, not report the power headroom information of the candidate cell group.

In some embodiments, the transmitting module 210 is further configured to: transmit the configuration information to the user equipment, where the configuration information is configured to instruct the user equipment to report, based on the configuration information, power headroom information of the candidate cell group, and the power headroom information includes power headroom information of the activated cell group.

In some embodiments, the transmitting module 210 is further configured to: transmit the configuration information to the user equipment, where the configuration information is configured to instruct the user equipment to report, based on the configuration information, power headroom information, and the power headroom information includes at least one of: power headroom information of a deactivated cell group, or power headroom information of an activated cell group.

In some embodiments, the transmitting module 210 is further configured to: transmit instruction information to the user equipment, where the instruction information is configured to instruct the user equipment to perform, based on the configuration information and instruction information received, the power headroom report.

In some embodiments, the transmitting module 210 is further configured to: transmit the third instruction information to the user equipment, where the third instruction information is configured to instruct the user equipment to: report at least one of: power headroom information of a deactivated cell group in the candidate cell group of a MAC entity, or power headroom information of an activated cell group in the candidate cell group of the MAC entity; and report, based on the first instruction information, at least one of: the power headroom information of the deactivated cell group, or the power headroom information of the activated cell group.

In some embodiments, the transmitting module 210 is further configured to: transmit fourth instruction information to the user equipment, where the fourth instruction information is configured to instruct the user equipment to: prohibit reporting at least one of: power headroom information of a deactivated cell group in the candidate cell group of a MAC entity, or power headroom information of an activated cell group in the candidate cell group of the MAC entity; and prohibit, based on the second instruction information, reporting at least one of: the power headroom information of the deactivated cell group, or the power headroom information of the activated cell group.

In some embodiments, the instruction information includes: radio resource control (RRC) information or media access control control element (MAC CE) information.

In some embodiments, the configuration information includes instruction information.

In some embodiments, the configuration information includes a power headroom report configuration, and the transmitting module 200 is further configured to: transmit the instruction information to the user equipment, where the instruction information is configured to instruct the user equipment to: in response to the configuration information being configured for activating the candidate cell group, in a case that the candidate cell group is activated based on the configuration information, report, based on the power headroom report configuration and the instruction information, power headroom information of the candidate cell group.

In some embodiments, the MAC entity is a MAC entity transmitting the configuration information or another MAC entity.

In some embodiments, the candidate cell group includes at least one of: a master cell group, a secondary cell group, a primary cell, a primary secondary cell, or a secondary cell.

Regarding the apparatuses in the above examples, the specific manner in which each module performs operations has been described in detail in the examples of the methods, and will not be described in detail here.

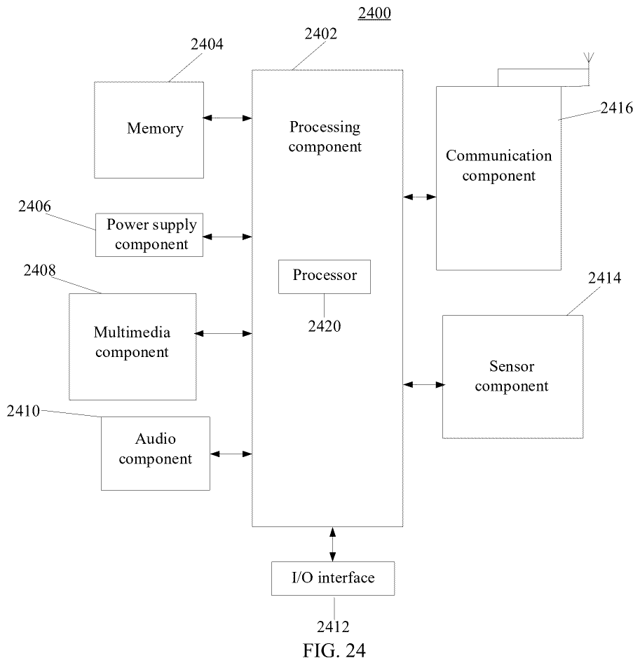

FIG. 24 is a block diagram illustrating a UE 2400 according to an embodiment of the present disclosure. For example, the UE 2400 can be the synchronization device or the measurement device. The UE 2400 may be a mobile phone, a computer, a digital broadcast terminal, a message transmitting and receiving device, a game console, a tablet device, a medical device, a fitness device and a personal digital assistant and so on.

As shown in FIG. 24, the UE 2400 may include one or more of the following components: a processing component 2402, a memory 2404, a power supply component 2406, a multimedia component 2408, an audio component 2410, an input/output (I/O) interface 2412, a sensor component 2414, and a communication component 2416.

The processing component 2402 generally controls overall operations of the UE 2400, such as operations associated with display, phone calls, data communications, camera operations, and recording operations. The processing component 2402 may include one or more processors 2420 to execute instructions to complete all or a part of the steps of the method. Further, the processing component 2402 may include one or more modules to facilitate interaction between the processing component 2402 and another component. For example, the processing component 2402 may include a multimedia module to facilitate the interaction between the multimedia component 2408 and the processing component 2402.

The memory 2404 is configured to store different types of data to support operations at the UE 2400. Examples of such data include instructions of any application program or method operable on the UE 2400, contact data, telephone directory data, messages, pictures, videos, and the like. The memory 2404 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 2406 provides power to different components of the UE 2400. The power supply component 2406 may include a power supply management system, one or more power supplies, and other components associated with generating, managing and distributing power for the UE 2400.

The multimedia component 2408 may include a screen for providing an output interface between the UE 2400 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 2408 may include a front camera and/or a rear camera. When the UE 2400 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 2410 is configured to output and/or input an audio signal. For example, the audio component 2410 may include a microphone (MIC). When the UE 2400 is in an operating mode, such as a call mode, a recording mode and a speech recognition mode, the microphone is configured to receive an external audio signal. The received audio signal may be further stored in the memory 2404 or sent via the communication component 2416. In some embodiments, the audio component 2410 also includes a speaker for outputting an audio signal.

The I/O interface 2412 may provide an interface between the processing component 2402 and peripheral interface modules. The above peripheral interface modules may include a keyboard, a click wheel, buttons and so on. Such buttons may include but not limited to: a home button, a volume button, a start button and a lock button.

The sensor component 2414 may include one or more sensors for providing state assessments in different aspects for the UE 2400. For example, the sensor component 2414 may detect the on/off state of the UE 2400, and relative locations of components, such as a display and a small keyboard of the UE 2400. The sensor component 2414 may also detect a position change of the UE 2400 or a component of the UE 2400, the presence or absence of contact of a user with the UE 2400, an orientation or acceleration/deceleration of the UE 2400 and a temperature change of the UE 2400. The sensor component 2414 may include a proximity sensor configured to detect presence of a nearby object without any physical contact. The sensor component 2414 may also include an optical sensor, such as a CMOS or CCD image sensor used in an imaging application. In some embodiments, the sensor component 2414 may also include an acceleration sensor, a gyroscope sensor, a magnetic sensor, a pressure sensor, or a temperature sensor.

The communication component 2416 is configured to facilitate wired or wireless communication between the UE 2400 and other devices. The UE 2400 may access a wireless network based on a communication standard, such as Wi-Fi, 2nd generation (2G) network or 3th generation (3G) network, or a combination thereof. In some embodiments, the communication component 2416 may receive a broadcast signal or broadcast-related information from an external broadcast management system via a broadcast channel. In some embodiments, the communication component 2416 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology and other technologies.

In some illustrative embodiments, the UE 2400 may be implemented by one or more of an application-specific integrated circuit (ASIC), a digital signal processor (DSP), a digital signal processing device (DSPD), programmable logical device (PLD), field programmable gate array (FPGA), a controller, microcontroller, a microprocessor or other electronic components to execute the method for reporting power headroom information.

In an example, a non-transitory machine readable storage medium storing machine executable instructions is provided, such as the memory 2404 storing instructions. The instructions may cause the processor 2420 in the UE 2400 to perform the method. For example, the non-transitory computer readable storage medium may be a read-only memory (ROM), a random access memory (RAM), a CD-ROM, a magnetic tape, a floppy disk and an optical data storage device, etc.

The device can be not only an independent user equipment, but also a part of the independent user equipment. For example, in an embodiment, the device can be an integrated circuit (IC) or a chip, where the integrated circuit can be one IC or a collection of multiple ICs. The chip may include, but is not limited to, the following types: graphics processing unit (GPU), central processing unit (CPU), field programmable gate array (FPGA), digital signal processor (DSP), application specific integrated circuit (ASIC), system on chip (SoC), etc. The integrated circuit or chip can be used to execute executable instructions (or codes) to realize the method for reporting power headroom information. The executable instructions can be stored in the integrated circuit or chip, and can also be obtained from other apparatuses or devices. For example, the integrated circuit or chip includes a processor, a memory, and an interface for communicating with other devices. The executable instructions can be stored in the processor, and the executable instructions, when executed by the processor, cause the processor to perform the method for reporting power headroom information. Alternatively, the integrated circuit or chip can receive the executable instructions through the interface and transmit the executable instructions to the processor for execution, so as to realize the method for reporting power headroom information.

In another embodiment, a computer program product is also provided, which includes computer programs that can be executed by a programmable device, the computer programs have codes, and the codes, when executed by the programmable device, cause the programmable device to perform the method for reporting power headroom information.

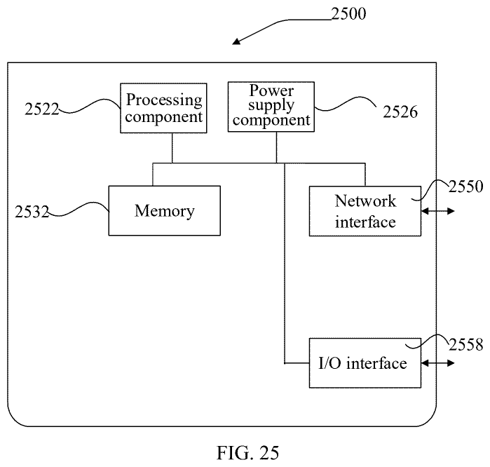

FIG. 25 is a block diagram illustrating a network device 2500 according to an embodiment of the present disclosure. For example, the network device 2500 can be provided as a server, which can serve as the synchronization device or the measurement device. Referring to FIG. 25, the network device 2500 includes a processing component 2522, which further includes one or more processors, and memory resources represented by a memory 2532 for storing instructions, such as an application program, that may be executed by the processing component 2522. The application program stored in the memory 2532 may include one or more modules each corresponding to a set of instructions. In addition, the processing component 2522 is configured to execute the instructions to perform the method for reporting power headroom information.

The network device 2500 may further include: a power supply component 2526, configured to manage power supply of the network device 2500, a wired or wireless network interface 2550, configured to connect the network device 2500 to a network, and an input/output (I/O) interface 2558. The network device 2500 may operate an operating system stored in the memory 2532.

The embodiments of the present disclosure also provide a communication system, which may include at least one user equipment and at least one network device. The user equipment may be the user equipment 2400, and the network device may be the network device 2500. The type of the at least one network device may be a 4th generation (4G) network device and/or a 5th generation (5G) network device, and an evolved 4G network device and/or an evolved 5G network device. For example, it can be a base station or a core network device in a 4G network (or an evolved 4G network) or a 5G network (or an evolved 5G network), and can form a network architecture as shown in FIG. 2 or FIG. 3. The at least one user equipment can communicate with the network device in the network architecture to perform the method for reporting power headroom information.

In the technical solution, the user equipment receives the configuration information, which includes information for configuring the candidate cell group. Based on the configuration information, the user equipment determines whether to perform the power headroom report. Thus, the user equipment reports the power headroom based on the information for configuring the candidate cell group in the configuration information, and the configuration information clearly indicates how the user equipment triggers the power headroom report, so that the network device can schedule the uplink resources according to the power headroom reported by the user equipment.

After considering the specification and practicing the present disclosure, the persons of skill in the art may easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the disclosure is to be limited only by the appended claims.

1. A method for reporting power headroom information, performed by a user equipment and comprising:
receiving configuration information transmitted by a network device, wherein the configuration information comprises information for configuring a candidate cell group; and
determining, based on the configuration information, whether to perform a power headroom report.

2. The method of claim 1, wherein
determining, based on the configuration information, whether to perform the power headroom report comprises:
determining, based on the configuration information, an initial state of the candidate cell group; and
in a case that the initial state is an activated state, triggering the power headroom report;
wherein the method further comprises at least one of:
in a case that the initial state is a deactivated state, prohibiting performing, through the candidate cell group, the power headroom report; or
in a case that the initial state is a deactivated state, not reporting power headroom information of the candidate cell group.

3. (canceled)

4. The method of claim 1, wherein
determining, based on the configuration information, whether to perform the power headroom report comprises at least one of:
in response to the configuration information instructing the user equipment to activate any candidate cell group, triggering the power headroom report; or
in response to the configuration information indicating that a cell group currently activated by the user equipment is changed, triggering the power headroom report;
or
determining, based on the configuration information, whether to perform the power headroom report comprises:
in response to the configuration information instructing the user equipment to deactivate a target cell group, prohibiting performing, through the target cell group, the power headroom report.

5. (canceled)

6. The method of claim 1, wherein
determining, based on the configuration information, whether to perform the power headroom report comprises:
in a case that there is no activated cell group on the user equipment, prohibiting performing, through a media access control (MAC) entity, the power headroom report;
or
determining, based on the configuration information, whether to perform the power headroom report comprises:
in a case that the candidate cell group is an activated cell group, reporting power headroom information of the candidate cell group, or
in a case that the candidate cell group is a deactivated cell group, not reporting the power headroom information of the candidate cell group.

7-8. (canceled)

9. The method of claim 1, wherein the candidate cell group comprises at least one of: an activated cell group or a deactivated cell group, and
wherein determining, based on the configuration information, whether to perform the power headroom report comprises:
determining, based on the configuration information, at least one of: the activated cell group in the candidate cell group or the deactivated cell group in the candidate cell group; and
reporting power headroom information wherein the power headroom information comprises at least one of: power headroom information of the activated cell group or power headroom information of the deactivated cell group.

10. (canceled)

11. The method of claim 1, wherein determining, based on the configuration information, whether to perform the power headroom report comprises:
performing, based on the configuration information and instruction information received, the power headroom report.

12. The method of claim 11, wherein the instruction information is first instruction information, and
wherein performing, based on the configuration information and the instruction information received, the power headroom report comprises:
obtaining the first instruction information, wherein the first instruction information is configured to instruct the user equipment to report at least one of: power headroom information of a deactivated cell group in the candidate cell group of a media access control (MAC) entity, or power headroom information of an activated cell group in the candidate cell group of the MAC entity; and
reporting, based on the first instruction information, at least one of: the power headroom information of the deactivated cell group, or the power headroom information of the activated cell group.

13. The method of claim 11, further comprising:
obtaining a second instruction information, wherein the second instruction information is configured to instruct the user equipment to prohibit reporting at least one of: power headroom information of a deactivated cell group in the candidate cell group of a media access control (MAC) entity, or power headroom information of an activated cell group in the candidate cell group of the MAC entity; and
prohibiting, based on the second instruction information, reporting at least one of: the power headroom information of the deactivated cell group, or the power headroom information of the activated cell group.

14. The method of claim 11, wherein the instruction information comprises: radio resource control (RRC) information or media access control control element (MAC CE) information; and
wherein the configuration information comprises the instruction information.

15. (canceled)

16. The method of claim 11, wherein the configuration information comprises a power headroom report configuration, and
wherein performing, based on the configuration information and the instruction information received, the power headroom report comprises:
in response to the configuration information being configured for activating the candidate cell group, in a case that the candidate cell group is activated based on the configuration information, reporting, based on the power headroom report configuration and the instruction information, power headroom information of the candidate cell group.

17-18. (canceled)

19. A method for reporting power headroom information, performed by a network device and comprising:
transmitting configuration information to a user equipment, wherein the configuration information comprises information for configuring a candidate cell group, and the configuration information is configured to instruct the user equipment to determine, based on the configuration information, whether to perform a power headroom report.

20. The method of claim 19, wherein transmitting the configuration information to the user equipment comprises:
transmitting the configuration information to the user equipment, wherein the configuration information is configured to instruct the user equipment to: determine, based on the configuration information, the initial state of the candidate cell group; trigger the power headroom report in a case that the initial state is an activated state; and in a case that the initial state is a deactivated state, at least one of: prohibit performing, through the candidate cell group, the power headroom report, or not report power headroom information of the candidate cell group.

21. (canceled)

22. The method of claim 19, wherein transmitting the configuration information to the user equipment comprises:
transmitting the configuration information to the user equipment, wherein the configuration information is configured to instruct the user equipment to at least one of: in response to the configuration information instructing the user equipment to activate any candidate cell group, trigger, based on the configuration information, the power headroom report; or in response to the configuration information indicating that a cell group currently activated by the user equipment is changed, trigger, based on the configuration information, the power headroom report;
or
transmitting the configuration information to the user equipment, wherein the configuration information is configured to instruct the user equipment to, in response to the user equipment deactivating a target cell group, prohibit, based on the configuration information, performing, through the target cell group, the power headroom report.

23. (canceled)

24. The method of claim 19, wherein transmitting the configuration information to the user equipment comprises one of:
transmitting the configuration information to the user equipment, wherein the configuration information is configured to instruct the user equipment to, in a case that there is no activated cell group on the user equipment, prohibit performing, through a media access control (MAC) entity, the power headroom report;
or
transmitting the configuration information to the user equipment, wherein the configuration information is configured to instruct the user equipment to, in a case that the candidate cell group is an activated cell group, report power headroom information of the candidate cell group;
or
transmitting the configuration information to the user equipment, wherein the configuration information is configured to instruct the user equipment to, in a case that the candidate cell group is a deactivated cell group, not report the power headroom information of the candidate cell group.

25-26. (canceled)

27. The method of claim 19, wherein the candidate cell group comprises at least one of: an activated cell group or a deactivated cell group, and
wherein transmitting the configuration information to the user equipment comprises:
transmitting the configuration information to the user equipment, wherein the configuration information is configured to instruct the user equipment to report, based on the configuration information, power headroom information, and the power headroom information comprises at least one of: power headroom information of the activated cell group or power headroom information of the deactivated cell group.

28. (canceled)

29. The method of claim 19, further comprising:
transmitting instruction information to the user equipment, wherein the instruction information is configured to instruct the user equipment to perform, based on the configuration information and instruction information received, the power headroom report.

30. The method of claim 29, wherein the instruction information is third instruction information, and
wherein transmitting the instruction information comprises:
transmitting the third instruction information to the user equipment, wherein the third instruction information is configured to instruct the user equipment to:
report at least one of: power headroom information of a deactivated cell group in the candidate cell group of a MAC entity, or power headroom information of an activated cell group in the candidate cell group of the MAC entity; and report, based on the third instruction information, at least one of: the power headroom information of the deactivated cell group, or the power headroom information of the activated cell group.

31. The method of claim 29, further comprising:
transmitting fourth instruction information to the user equipment, wherein the fourth instruction information is configured to instruct the user equipment to: prohibit reporting at least one of: power headroom information of a deactivated cell group in the candidate cell group of a media access control (MAC) entity, or power headroom information of an activated cell group in the candidate cell group of the MAC entity; and prohibit, based on the fourth instruction information, reporting at least one of: the power headroom information of the deactivated cell group, or the power headroom information of the activated cell group.

32-38. (canceled)

39. A user equipment, comprising:
a processor; and
a memory storing instructions executable by the processor;
wherein the instructions, when executed by the processor, cause the processor to perform operations comprising:
receiving configuration information transmitted by a network device, wherein the configuration information comprises information for configuring a candidate cell group; and
determining, based on the configuration information, whether to perform power headroom report.

40. A network device, comprising:
a processor; and
a memory storing instructions executable by the processor;
wherein the instructions, when executed by the processor, cause the processor to perform the method of claim 19.

41-42. (canceled)
